(19) United States
(12) Patent Application Publication
(10) Pub. No.: US 2026/0025319 A1
(43) Pub. Date: Jan. 22, 2026

(54) Methods And Apparatus Of Cluster-Based Measurement Prediction In Mobile Communications

(71) Applicant: MediaTek Singapore Pte. Ltd., Singapore (SG)

(72) Inventors: Yao Peng, Beijing (CN); Yuanyuan Zhang, Beijing (CN); Xiaonan Zhang, Beijing (CN); Ta-Yuan Liu, Hsinchu City (TW); Wei Chen, Beijing (CN); Wen Li, Beijing (CN); Shiyue Wang, Beijing (CN); Bo Ai, Beijing (CN)

(21) Appl. No.: 19/268,921

(22) Filed: Jul. 14, 2025

(30) Foreign Application Priority Data
Jul. 17, 2024 (WO) PCT/CN2024/105946
Jul. 1, 2025 (CN) 202510908802.0

(51) Int. Cl. H04L 41/16; H04W 36/00

(52) U.S. Cl. CPC H04L 41/16; H04W 36/0085

(57) ABSTRACT

Various solutions for cluster-based measurement prediction in mobile communications are described. A user equipment (UE) may perform a first measurement on a first cell cluster. The UE may obtain first predicted results associated with a second cell cluster based on a first artificial intelligence (AI) or machine learning (ML) based model and first measurement results of the first measurement. The UE may determine that it moves from the first cell to a second cell. The first predicted results are associated with the first cell and the second cell in an event that the first cell and the second cell belong to the second cell cluster. Accordingly, no AI or ML model update is needed for UE movement between cells belonging to the same cluster, thus reducing the overhead.

### CROSS REFERENCE TO RELATED PATENT APPLICATION(S)

The present disclosure is part of a non-provisional application claiming the priority benefit of PCT Application No. PCT/CN2024/105946, filed 17 Jul. 2024, and CN application No. 202510908802.0, filed 1 Jul. 2025. The contents of aforementioned applications are herein incorporated by reference in their entirety.

### TECHNICAL FIELD

The present disclosure is generally related to mobile communications and, more particularly, to cluster-based measurement prediction with respect to user equipment and network apparatus in mobile communications.

### BACKGROUND

Unless otherwise indicated herein, approaches described in this section are not prior art to the claims listed below and are not admitted as prior art by inclusion in this section.

In 3rd generation partnership project (3GPP) 5G new radio (NR) networks, user equipment (UE) mobility is an important consideration. To maintain service continuity and quality, the UE measures and reports radio resource signal environment quality. However, legacy handover (HO) designs, controlled by layer 3 (L3) procedures including radio resource management (RRM) measurement and radio resource control (RRC) reconfiguration, introduce a significant amount of signaling and latency. To address this, lower-layer triggered mobility (LTM, also known as layer 1 (L1)/layer 2 (L2) triggered mobility) is introduced to enable serving cell changes via beam management with L1/L2 signaling, reducing latency, overhead, and interruption during UE mobility.

On the other hand, with the increasing integration of artificial intelligence (AI) or machine learning (ML) to enhance network performance, leveraging AI/ML to further improve mobility procedures, such as enabling proactive measurement reports (MR) and handovers, and/or reducing unnecessary handovers, has become an important issue. The requirement for the UE to switch or transfer a new cell-specific model upon entering each new cell poses a significant challenge. This process involves transmitting a substantial volume of model parameters during UE mobility, consequently increasing network load and introducing latency. Thus, a solution to solve this problem is needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to cluster-based measurement prediction with artificial intelligence or machine learning (AI/ML) based model with respect to user equipment (UE) and network apparatus in mobile communications.

In one aspect, a method may involve an apparatus performing a first measurement on a first cell cluster. The method may also involve the apparatus obtaining first predicted results associated with a second cell cluster based on a first AI/ML based model and first measurement results of the first measurement. The method may also involve the apparatus determining that the apparatus moves from the first cell to a second cell. The first predicted results are associated with the first cell and the second cell in an event that the first cell and the second cell belong to the second cell cluster.

In another aspect, an apparatus may comprise a transceiver which, during operation, wirelessly communicates with a network. The apparatus may also comprise a processor communicatively coupled to the transceiver. The processor, during operation, may perform operations comprising performing a first measurement on a first cell cluster. The processor, during operation, may perform operations comprising obtaining first predicted results associated with a second cell cluster based on a first AI/ML based model and first measurement results of the first measurement. The processor, during operation, may perform operations comprising determining that the apparatus moves from the first cell to a second cell. The first predicted results are associated with the first cell and the second cell in an event that the first cell and the second cell belong to the second cell cluster.

In yet another aspect, a method may involve a network node receiving first measurement results associated with a first cell cluster and second measurement results associated with a second cell cluster from a UE. The method may also involve the network node training an AI/ML based model by using the first measurement results as model input and the second measurement results as label. The method may further involve the network node providing the AI/ML based model to the UE for measurement predictions for at least two cells belonging to the second cell cluster.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting example scenarios of cell-based prediction and cluster-based prediction in accordance with implementations of the present disclosure.

FIG. 3 is a diagram depicting example scenarios of two cell clusters associated with a cluster-based AI/ML model in accordance with implementations of the present disclosure.

FIG. 4 is a diagram depicting example scenarios of training phase and inference phase for different AI/ML models.

FIG. 5 is a diagram depicting example scenarios of training phase and inference phase for cluster-based AI/ML model in accordance with implementations of the present disclosure.

FIG. 6 is a diagram depicting an example scenario of measurement level of cluster-based AI/ML model in accordance with implementations of the present disclosure.

FIG. 7 is a diagram depicting example scenarios of prediction domain of cluster-based AI/ML model in accordance with implementations of the present disclosure.

FIG. 8 is a diagram depicting an example procedure of RRM prediction measurement procedure in accordance with implementations of the present disclosure.

FIG. 9 is a block diagram of an example communication system in accordance with an implementation of the present disclosure.

FIG. 10 is a flowchart of an example process in accordance with an implementation of the present disclosure.

FIG. 11 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions s pertaining to cluster-based measurement prediction using artificial intelligence or machine learning (also referred to as “AI or ML” or “AI/ML”) based model in mobile communications. According to the present disclosure, a number of possible solutions may be implemented separately or jointly. That is, although these possible solutions may be described below separately, two or more of these possible solutions may be implemented in one combination or another.

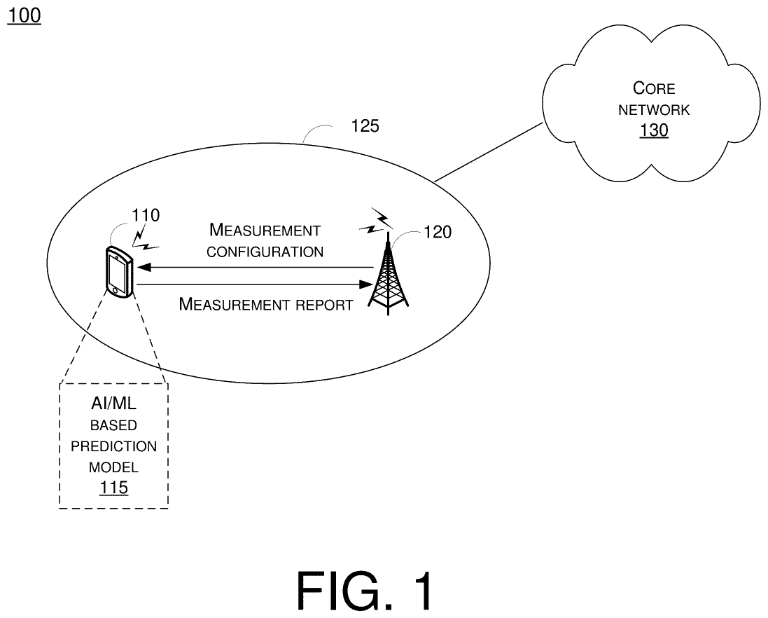

FIG. 1 illustrates an example scenario 100 of a communication environment in which various solutions and schemes in accordance with the present disclosure may be implemented. Scenario 100 involves a user equipment (UE) 110 in wireless communication with a wireless network consisting of an access network 125 and a core network (CN) 130. The wireless network may be a 5G NR network, 5G-Advanced network, 6G network, however, the present disclosure is not limited thereto. The UE 110 may be a smart phone, a wearable device, an IoT device, and a tablet, etc. Alternatively, the UE 110 may be a notebook (NB) or personal computer (PC) inserted or installed with a data card which includes a modem and radio frequency (RF) transceiver(s) to provide the functionality of wireless communication. The CN 130 may include entities such as user plane function (UPF), mobility management function (AMF), session management function (SMF) and unified data management (UDM), etc. The access network 125 may include one or more base stations (BSs), such as the BS 120. The BS 120 may be an evolved NodeBs (eNB), a next generation NodeB (gNB), or a transmission and reception point (TRP), but the present disclosure is not limited thereto. The BS 120 may provide communication coverage for a serving area where communications with the UE 110 is supported. For example, the BS 120 may serve a number of UEs within the serving area (e.g., a cell, or within a cell sector). In some systems, one or more BSs are coupled to a controller forming an access network that is coupled to one or more core networks.

In scenario 100, the UE 110 may establish a connection (e.g., a radio resource control (RRC) connection) with the BS 120. The BS 120 may provide a measurement configuration (e.g., time to trigger (TTT) and offset) to the UE 110 by RRC signaling. The BS 120 may request the UE 110 to measure intra-frequency and/or inter-frequency measurements. The UE 110 may perform the measurements (e.g., the radio resource management (RRM) measurements) according to the measurement configuration and evaluate the reporting criteria (also referred to as the reporting condition) for triggering the transmission of a measurement report based on the measurement results. In scenario 100, an AI/ML based prediction module 115 including one or more AI/ML based models (also referred to as AI/ML models) is at the UE side. The UE 110 may perform measurement prediction by using the AI/ML based prediction module 115 and report the model output to the BS 120. Accordingly, the BS 120 may make a handover decision and send a handover command to the UE 110. The predicted results may be obtained by performing a measurement prediction at one or a combination of a temporal domain, a spatial domain, and a frequency domain with the AI/ML based model.

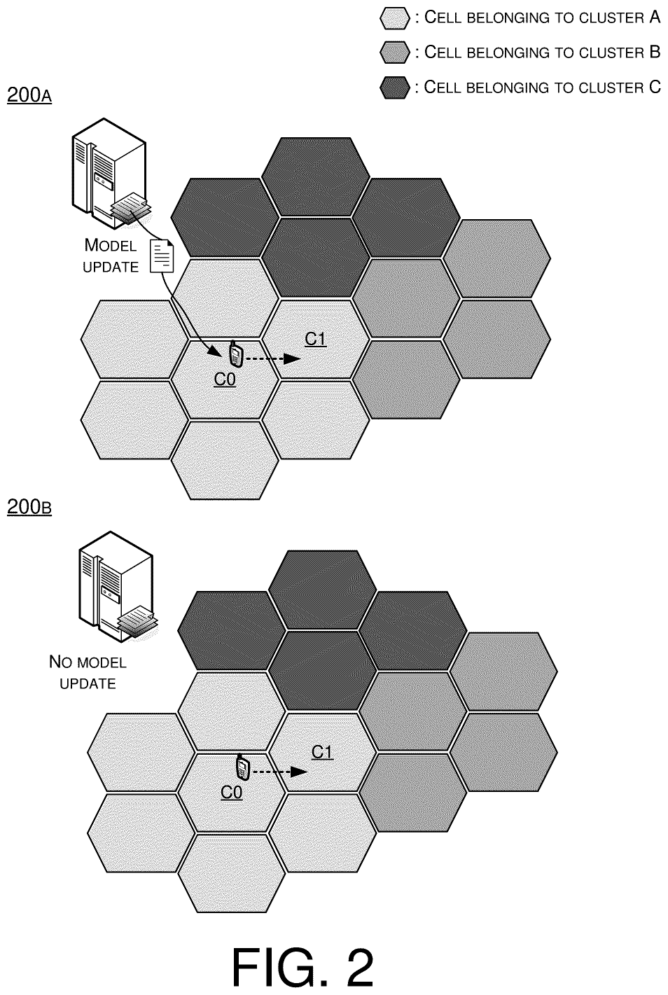

In the present disclosure, a cluster-based RRM measurements prediction is provided. While a UE moves between different cells, no AI/ML model update is needed if the source cell and the target cell belong to the same cluster. The conditional sharing of an AI/ML based model for RRM measurement prediction among multiple cells offers the potential to decrease model/signaling overhead and improve prediction accuracy. FIG. 2 is a diagram depicting example scenarios of cell-based prediction and cluster-based prediction in accordance with implementations of the present disclosure. As shown in FIG. 2, the cells are grouped into three clusters (A, B, and C) based on one or a combination of signal measurements, geographical information (e.g., BS geographical coordinates), radio access network (RAN) configuration, beam configuration, operating frequency, bandwidth, transmission power, and antenna height. Alternatively, the cluster may be determined based on UE implementation. In scenario 200a, a cell-based AI/ML model is applicable for individual cells. Consequently, a model update is necessary when the UE moves from a cell (e.g., C0) to a new cell (e.g., C1) that necessitates a different AI/ML model for RRM measurement prediction. Thus, it is needed to perform a model update whenever the UE moves out of a cell. However, in scenario 200b, a cluster-based AI/ML model is applicable to all cells within a cluster, thus eliminating the need for model updates when moving between these cells. Accordingly, no model update is required when the UE moves from cell C0 to cell C1, as both belong to cluster A.

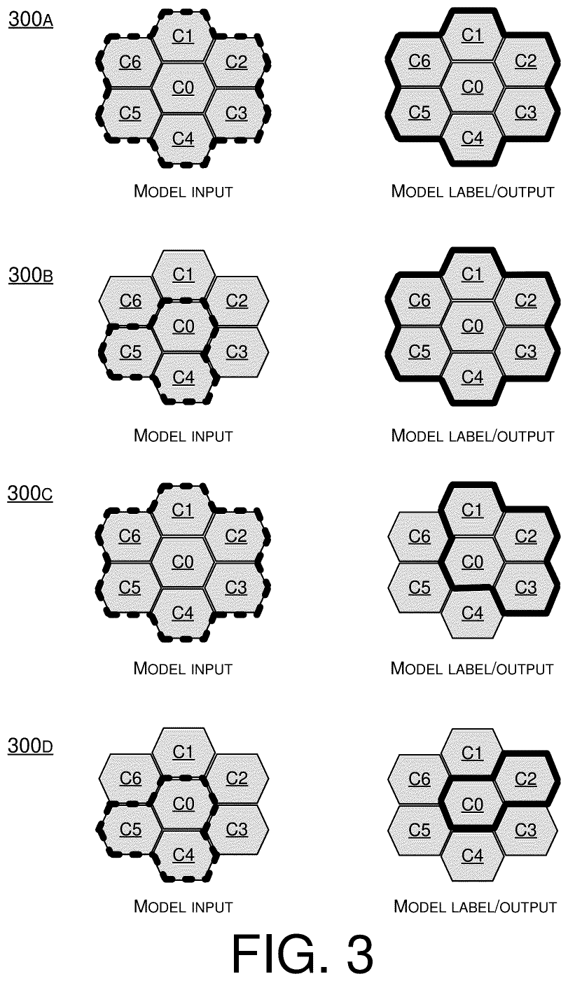

A cluster-based AI/ML model is associated with, for example, two cell clusters. At the training phase, the model input is the measurement results associated with a first cell cluster (also referred to as a first cluster), and the label is the measurement results associated with a second cell cluster (also referred to as a second cluster). The model may be trained with or without assistance information such as UE position/speed. At the inference phase, the model input is the measurement results associated with the first cell cluster, and the model output is the predicted results associated with the second cell cluster. The measurement for model input and label/output is defined by one or a combination of a spatial domain, a temporal domain, and a frequency domain. The data format of measurement may include one or a combination of a cell identifier (ID), a beam ID, a beam quantity and a cell quantity, however, the present disclosure is not limited thereto. FIG. 3 is a diagram depicting example scenarios of two cell clusters associated with a cluster-based AI/ML model in accordance with implementations of the present disclosure. In scenario 300a, the first cell cluster and the second cell cluster are identical (i.e., both include cells C0 to C6). No model update is needed when the UE moves between any of the cells C0 to C6. In scenario 300b, the first cell cluster is a subset of the second cell cluster. Specifically, the first cell cluster includes cells C0, C4, and C5, whereas the second cell cluster includes cells C0 through C6. Consequently, no model update is needed when the UE moves between any of the cells within the second cluster (C0 to C6). In scenario 300c, the second cell cluster is a subset of the first cell cluster as the first cell cluster includes cells C0 through C6, and the second cell cluster includes cells C0 through C3. No model update is needed when the UE moves between any of the cells within the second cluster (C0 to C3). In scenario 300d, the first cell cluster overlaps with the second cell cluster. Specifically, the first cell cluster includes cells C0, C4, and C5, while the second cell cluster includes cells C0 and C2. In other words, the first and second cell clusters have a partial intersection, specifically cell C0. In scenario 300d, when the UE moves between C0 and C2, no model update is needed. It should be noted that although the first/second cell cluster includes multiple cells in scenarios 300a through 300d, the present disclosure is not limited thereto. The first/second cell cluster may include one cell. In one embodiment, the AI/ML model is trained at the network side and delivered from a UE server to the UE. Alternatively, the AI/ML model may be trained at the UE side and delivered from a network (NW) server to the UE.

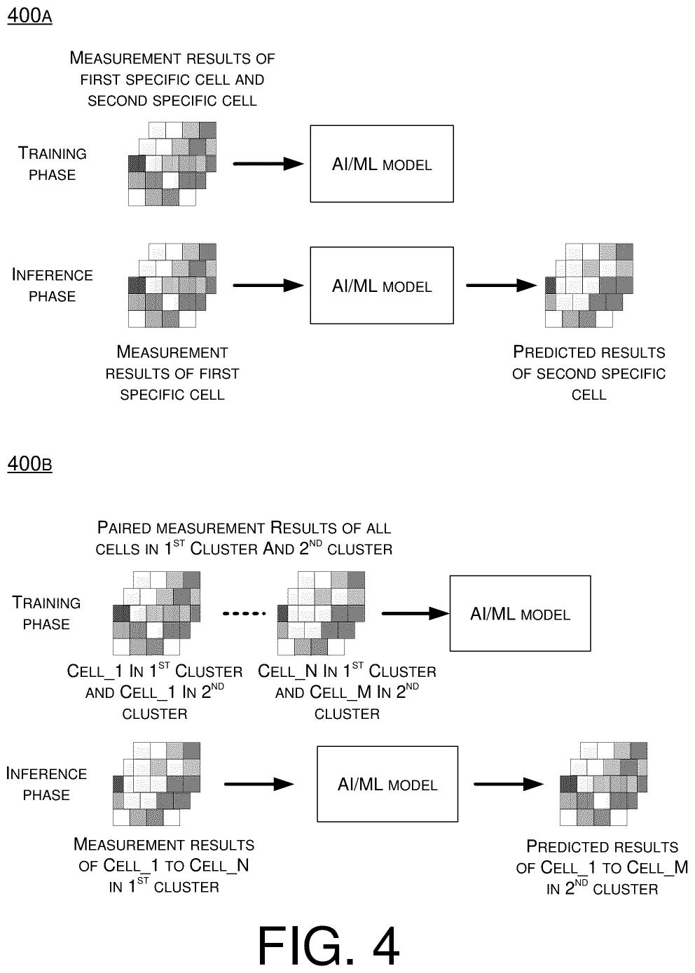

FIG. 4 is a diagram depicting example scenarios of training phase and inference phase for different AI/ML models. In scenario 400a, a cell-based AI/ML model is used for individual cells. During training, measurement results from a first specific cell are used as input, and measurement results from a second specific cell serve as the label. The trained model may be used for predicting the measurement results of the second specific cell based on the measurement results from the first specific cell as model input. In scenario 400b, a cluster-based AI/ML model is applicable for all cells within a cluster. During training, measurement results from all cells in the first cell cluster serve as input, and those from all cells in the second cell cluster serve as the label. The trained model may be used to predict the measurement results of all or a partial of cells in the second cell cluster using the measurement results of the first cell cluster as input.

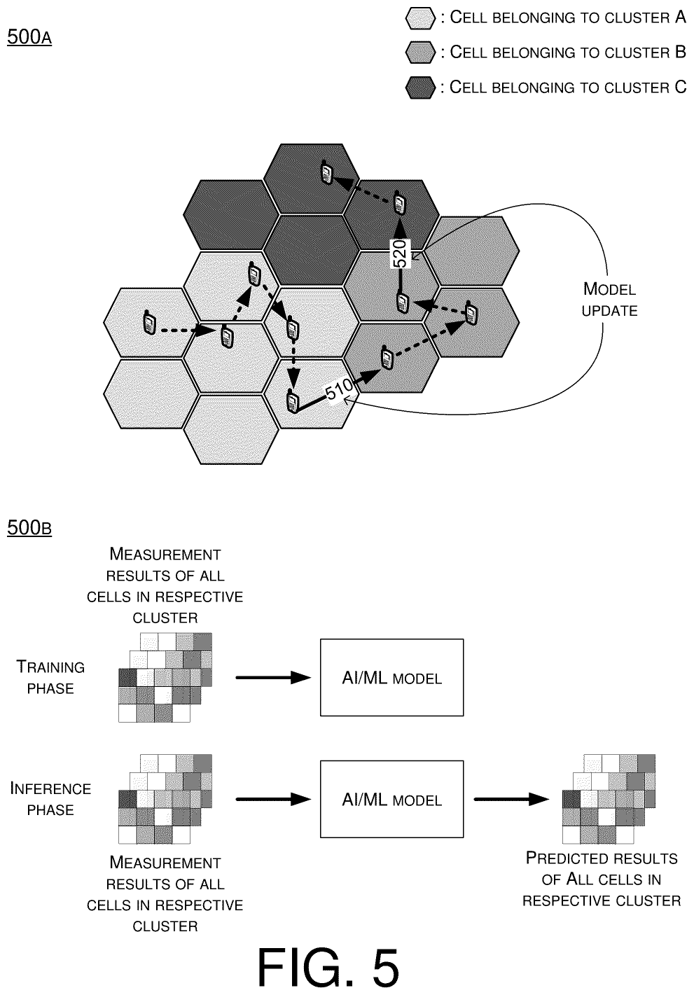

FIG. 5 is a diagram depicting example scenarios of training phase and inference phase for cluster-based AI/ML model in accordance with implementations of the present disclosure. In scenario 500a, a UE traverses 10 cells, resulting in 9 cell switches. Given the support for cluster-based RRM measurement prediction, model updates are triggered solely by inter-cluster movements: specifically, movement 510 from cluster A to B, and movement 520 from cluster B to C. Consequently, the other 7 intra-cluster movements do not necessitate model updates (i.e., the transfer/switching of a new AI/ML model is not required). In scenario 500b, a dedicated AI/ML model is trained for each cluster (A, B, and C) using measurements from the respective cluster. For instance, during the model training phase for cluster A, measurement results from its 7 cells serve as both the model input and the label. Subsequently, this trained model may be applied to any of the 7 cells within cluster A to generate predicted results during the inference phase. Similar training and inference procedures are used for the AI/ML models of clusters B and C.

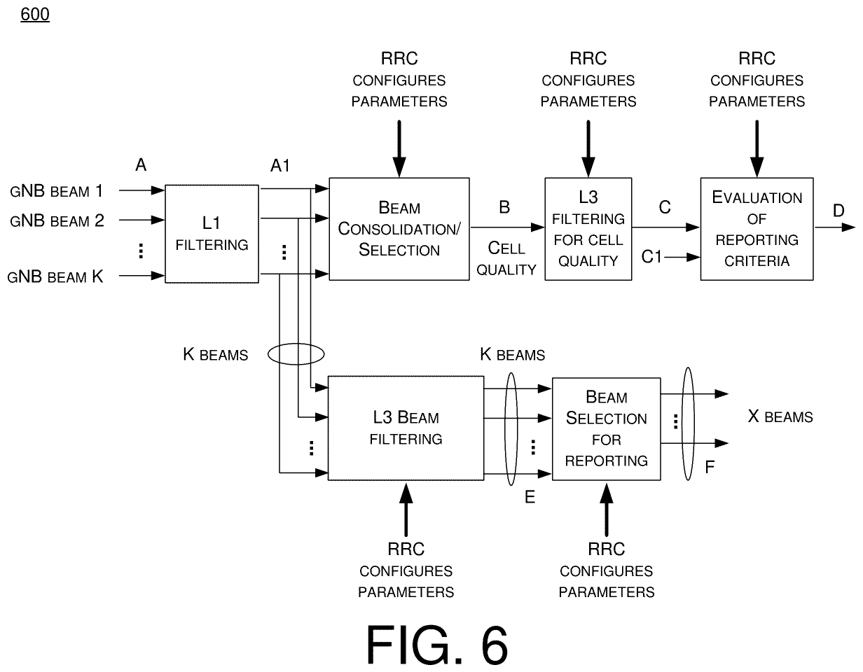

FIG. 6 is a diagram depicting an example scenario of measurement level of cluster-based AI/ML model in accordance with implementations of the present disclosure. Scenario 600 involves a measurement procedure including beam-level and cell-level filtering. In a connected state (e.g., RRC CONNECTED state), a UE measures multiple beams (at least one) of a cell, and the measurements results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE is configured to do so by the gNB. Scenario 600 includes a layer 1 (L1) filtering stage, a beam consolidation/selection stage, a layer 3 (L3) filtering for cell quality stage, an evaluation of reporting criteria stage, an L3 beam filtering stage, and a beam selection for reporting stage. In scenario 600, K beams correspond to the measurements on synchronization signal block (SSB) or channel state information-reference signal (CSI-RS) resources configured for L3 mobility by gNB and detected by a UE at L1. Point A is the measurements (beam specific samples) internal to the physical layer. The L1 filtering stage includes an internal L1 filtering of the inputs measured at point A and the implementation is up to UE. Point A1 represents the measurements reported by L1 to L3 after L1 filtering. The beam consolidation/selection stage performs the consolidation of beam specific measurements to derive cell quality. The L3 filtering for the cell quality stage performs filtering on the measurements provided at point B. Point C is the measurement after processing of L3 filtering for cell quality. The evaluation of reporting criteria stage checks whether actual measurement reporting is necessary at point D. That is, the measurement report information (message) may be sent at point D. The L3 beam filtering stage filters the measurement provided at point A1. The beam selection for the beam reporting stage selects X measurements from the measurements provided at point E. The behavior of the beam consolidation/selection stage, L3 filtering for cell quality stage, evaluation of reporting criteria stage, L3 beam filtering stage, and beam selection for the beam reporting stage is standardized. The configuration of these stages is provided by RRC signaling. In the present disclosure, one or more AI/ML based models may be incorporated into the flow of the measurement procedure. In the following embodiments, the first cluster cells refer to the cells in the first cell cluster, the measurement thereof is used for model input. The second cluster cells, which are the cells within the second cell cluster, have measurements and predictions that correspond to the label and model output, respectively. The first/second cluster cells may be the serving cells and the neighboring cells of intra-frequency or inter-frequency.

In one embodiment, the measurement of the first cluster cells (as model input) is L1 beam level measurement results without L1 filtering at point A. The measurement/prediction of the second cluster cells is: without L1 filtering at point A; with L1 filtering at point A1; L1 cell level results at point B; L3 beam level results at point E; or L3 cell level results at point C.

In one embodiment, the measurement of the first cluster cells (as model input) is L1 beam level measurement results with L1 filtering at point A1. The measurement/prediction of the second cluster cells is: measurement with L1 filtering at point A1; L1 cell level results at point B; L3 beam level results at point E; or L3 cell level results at point C.

In one embodiment, the measurement of the first cluster cells is L3 beam level measurement results at point E, the measurement/prediction of the second cluster cells is: L3 beam level results at point E; or L3 cell level results at point C.

In one embodiment, the measurement of the first cluster cells is L1 cell level measurement results at point B, the measurement/prediction of the second cluster cells is: L1 cell level results at point B; or L3 cell level results at point B.

In one embodiment, the measurement of the first cluster cells is L3 cell level measurement results at point C, the measurement/prediction of the second cluster cells is L3 cell level results at point C.

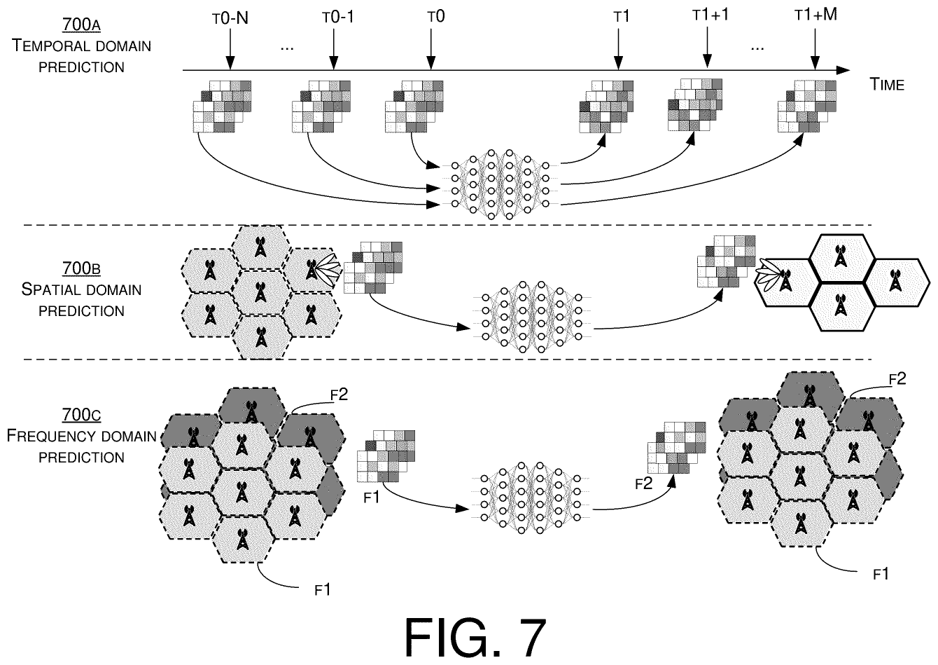

In the foregoing embodiments, the measurement for the first cluster cells and the measurement/prediction for the second cluster cells are applicable for the temporal domain, the frequency domain and any combinations of the domains. FIG. 7 is a diagram depicting example scenarios of prediction domain of cluster-based AI/ML model in accordance with implementations of the present disclosure. In scenario 700a, the measurement radio resource of first cell cluster and the second cell cluster are same in frequency and spatial domain, and the UE may perform measurement prediction at temporal domain, using historical measurement results [t0−N, t0] as model input and future measurement results [t1, t1+M] as label. In one embodiment, time point to is equal to time point t1. In another embodiment, time point to is less than time point t1.

In scenario 700b, the measurement radio resource of first cell cluster and the second cell cluster are same in frequency and temporal domain, and the UE may perform measurement prediction at spatial domain, using measurement results of partial beams of first cell cluster as model input and full or the other part of beam results of the second cell cluster as label.

In scenario 700c, the measurement radio resource of first cell cluster and the second cell cluster are same in spatial and temporal domain, and the UE may perform measurement prediction at frequency domain, using measurement results of first cell cluster with frequency 1 (F1) as model input and the second cell cluster with frequency 2 (F2) as label.

The prediction domain of the first cell cluster and the second cell cluster may be any combination of the temporal, spatial and frequency domain domains. In one embodiment, the measurement radio resource of first cell cluster and the second cell cluster are the same in spatial domain, and the UE may perform measurement prediction at temporal and frequency domain with the combination of scenario 700a and scenario 700c. In one embodiment, the measurement radio resource of the first cell cluster and the second cell cluster are the same in temporal domain, and the UE may perform measurement prediction at spatial and frequency domain with the combination of scenario 700b and scenario 700c. In one embodiment, the measurement radio resource of the first cell cluster and the second cell cluster are the same in frequency domain, and the UE may perform measurement prediction at temporal and spatial domain with the combination of scenario 700a and scenario 700b. In another embodiment, the measurement radio resource of first cell cluster and the second cell cluster are the same in temporal, spatial and frequency domain, and the UE may perform measurement prediction at temporal, spatial and frequency domain with the combination of scenario 700a, scenario 700b, and scenario 700c.

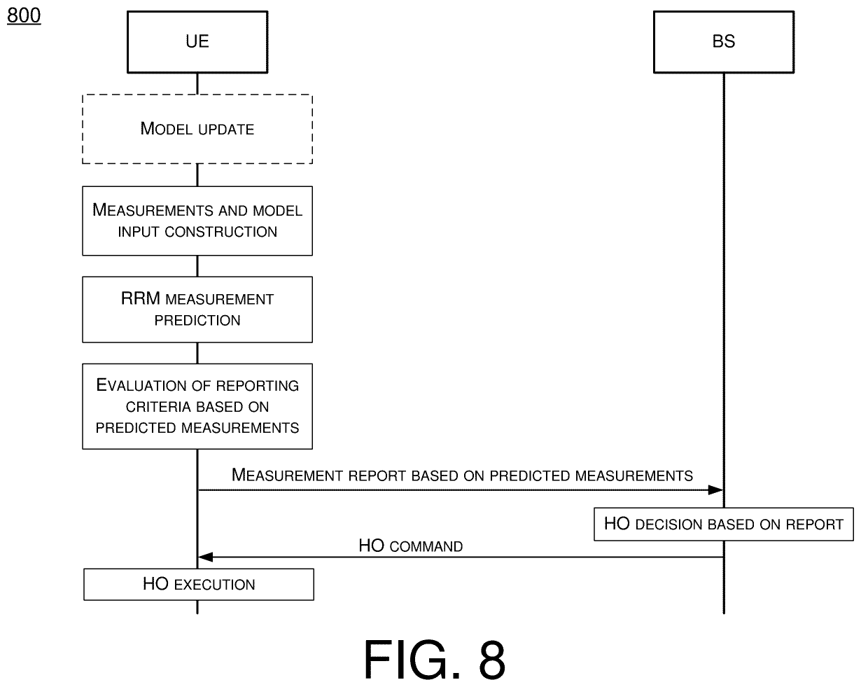

FIG. 8 is a diagram depicting an example procedure of RRM prediction measurement procedure in accordance with implementations of the present disclosure. In procedure 800, the UE may perform a model update upon moving to a different cell cluster. This update may occur autonomously, based on cluster updates, or as indicated by the RAN/network. In one example, the UE may pre-download models applicable for cluster(s) and perform the model update by model switching. Alternatively, if the UE does not pre-download models applicable for a certain cluster, it may perform the model update by model (parameters) transfer. Notably, when cluster-based RRM measurement prediction is supported, no model update is triggered for intra-cluster UE movements.

Once the applicable AI/ML model is obtained, the UE may perform measurements to gather input data and then utilize the model for RRM measurement prediction. In one example, for the temporal domain beam-quality prediction, the UE may perform full beam sweeping at the observation time window and stop beam sweeping at the prediction time window. In another example, for the temporal-spatial domain beam-quality prediction, the UE may perform partial beam sweeping at the observation time window. Then, the UE may evaluate the reporting criteria based on the measurement results which are actually measured, the measurement results which are predicted, or both according to the network configuration. The measurement report may include the measurement results which are actually measured, the measurement results which are predicted, or both according to the network configuration. The measured reference signal (RS) quality may be a signal to interference noise ratio (SINR), a reference signal received power (RSRP), or a reference signal received quality (RSRQ). Further, the UE 110 may report the measurement event based on predicted results, measured results, or a combination thereof, as configured by the BS 120. The BS may make a HO decision based on the report from the UE and send an HO command to the UE. Accordingly, the UE may perform an HO execution according to the HO command.

Cluster-based RRM measurement prediction may balance the generalization and complexity of AI/ML model by grouping cells with similar characteristics or geographical proximity into clusters and training a single AI/ML model to serve all cells within that cluster. This inherently reduces the complexity of the overall system by significantly decreasing the number of models required.

### Illustrative Implementations

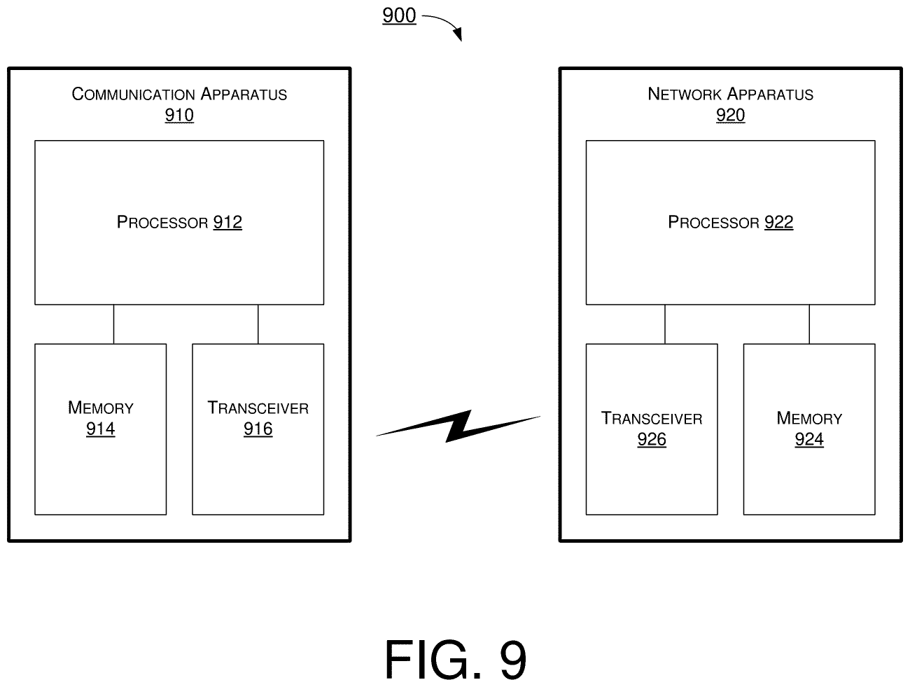

FIG. 9 illustrates an example communication system 900 having at least an example communication apparatus 910 and an example network apparatus 920 in accordance with an implementation of the present disclosure. Each of the communication apparatus 910 and network apparatus 920 may perform various functions to implement schemes, techniques, processes and methods described herein pertaining to cluster-based measurement prediction in mobile communications, including scenarios/schemes described above as well as processes 1000 and 1100 described below.

Communication apparatus 910 may be a part of an electronic apparatus, which may be a UE such as a portable or mobile apparatus, a wearable apparatus, a wireless communication apparatus or a computing apparatus. For instance, communication apparatus 910 may be implemented in a smartphone, a smartwatch, a personal digital assistant, a digital camera, or a computing equipment such as a tablet computer, a laptop computer or a notebook computer. Communication apparatus 910 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 910 may be implemented in a smart thermostat, a smart fridge, a smart door lock, a wireless speaker or a home control center. Alternatively, communication apparatus 910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 9 such as a processor 912, for example. Communication apparatus 910 may further include one or more other components not pertinent to the proposed scheme of the present disclosure (e.g., internal power supply, display device and/or user interface device), and, thus, such component(s) of communication apparatus 910 are neither shown in FIG. 9 nor described below in the interest of simplicity and brevity.

Network apparatus 920 may be a part of a network apparatus, which may be a network node such as a satellite, a base station, a small cell, a router or a gateway. For instance, network apparatus 920 may be implemented in an eNB in an LTE network, in a gNB in a 5G/NR, IoT, NB-IoT or IIoT network or in a satellite or base station in a 6G network. Alternatively, network apparatus 920 may be a UE server, a NW server, or an over the top (OTT) server. Network apparatus 920 may include at least some of those components shown in FIG. 9 such as a processor 922, for example. Processor 922 may further include protocol stacks and a set of control functional modules and circuits. Network apparatus 920 may further include one or more other components not pertinent to the proposed scheme of the present disclosure (e.g., internal power supply, display device and/or user interface device), and, thus, such component(s) of network apparatus 920 are neither shown in FIG. 9 nor described below in the interest of simplicity and brevity.

In one aspect, each of the processor 912 and processor 922 may be implemented in the form of one or more single-core processors, one or more multi-core processors, or one or more CISC processors. That is, even though a singular term “a processor” is used herein to refer to processor 912 and processor 922, each of the processor 912 and processor 922 may include multiple processors in some implementations and a single processor in other implementations in accordance with the present disclosure. In another aspect, each of the processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 912 and processor 922 is a special-purpose machine specifically designed, arranged and configured to perform specific tasks in a device (e.g., as represented by communication apparatus 910) and a network (e.g., as represented by network apparatus 920) in accordance with various implementations of the present disclosure.

In some implementations, communication apparatus 910 may also include a memory 914 coupled to processor 912 and capable of being accessed by processor 912 and storing data therein. In some implementations, communication apparatus 910 may further include a transceiver 916 coupled to processor 912 and capable of wirelessly transmitting and receiving data.

In some implementations, network apparatus 920 may further include a memory 924 coupled to processor 922 and capable of being accessed by processor 922 and storing data therein, and a transceiver 926 coupled to processor 922 and capable of wirelessly transmitting and receiving data. Accordingly, communication apparatus 910 and network apparatus 920 may wirelessly communicate with each other via transceiver 916 and transceiver 926, respectively.

For illustrative purposes and without limitation, descriptions of capabilities of the communication apparatus 910 and network apparatus 920 are provided below with process 1000 and process 1100. In which, communication apparatus 910 is implemented in or as a communication apparatus or a UE, and network apparatus 920 is implemented in or as a network node of a communication network (e.g., a base station or a UE server).

### Illustrative Processes

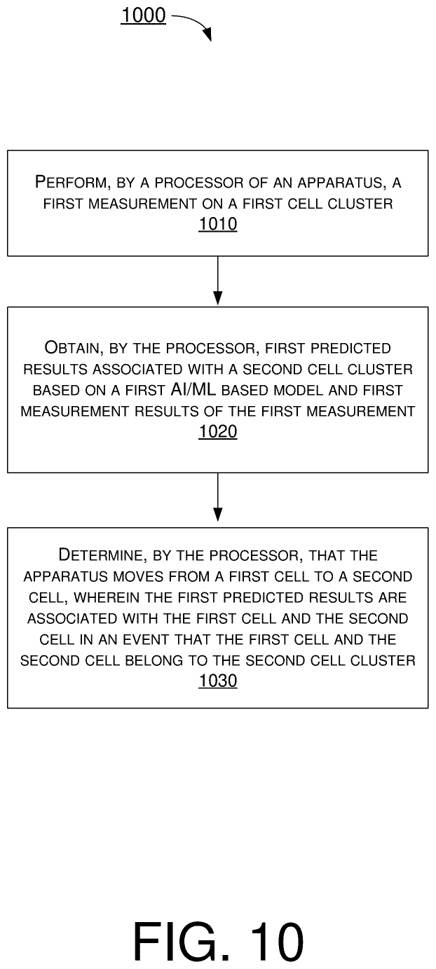

FIG. 10 illustrates an example process 1000 in accordance with an implementation of the present disclosure. Process 1000 may be an example implementation of above scenarios/schemes, whether partially or completely, with respect to cluster-based measurement prediction in mobile communications. Process 1000 may represent an aspect of implementation of features of communication apparatus 910. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 910 or any suitable UE (e.g., UE 110) or machine type devices. Solely for illustrative purposes and without limitation, process 1000 is described below in the context of communication apparatus 910 as a UE. Process 1000 may begin at block 1010.

At block 1010, process 1000 may involve processor 912 of communication apparatus 910 performing a first measurement on a first cell cluster. Process 1000 may proceed from block 1010 to block 1020.

At block 1020, process 1000 may involve processor 912 obtaining first predicted results associated with a second cell cluster based on a first AI/ML based model and first measurement results of the first measurement. Process 1000 may proceed from block 1020 to block 1030.

At block 1030, process 1000 may involve processor 912 determining that communication apparatus 910 moves from a first cell to a second cell. Specifically, the first predicted results are associated with the first cell and the second cell in an event that the first cell and the second cell belong to the second cell cluster.

In some implementations, process 1000 may also involve processor 912 performing a model update to obtain a second AI/ML based model in an event that the first cell belongs to the second cell cluster and the second cell belongs to a third cell cluster which is different from the second cell cluster. Furthermore, process 1000 may involve processor 912 obtaining second predicted results associated with the third cell cluster based on the second AI or ML based model.

In some implementations, the first cell cluster and/or the second cell cluster is determined based on one or a combination of signal measurements, geographical information, and RAN configuration.

In some implementations, the first cell cluster is identical to the second cell cluster.

In some implementations, the first cell cluster is a subset of the second cell cluster.

In some implementations, the first cell cluster is overlapping with the second cell cluster.

In some implementations, the first cell cluster and the second cell cluster may include one or more cells.

In some implementations, process 1000 may also involve processor 912 transmitting, via transceiver 916, a measurement report to a network node (e.g., network apparatus 920) according to the first measurement results associated with the first cell cluster, the first predicted results associated with the second cell cluster, or both.

In some implementations, the first predicted results associated with the second cell cluster are obtained by performing a measurement prediction at one or a combination of a temporal domain, a spatial domain, and a frequency domain with the first AI/ML based model.

In some implementations, process 1000 may also involve processor 912 collecting the first measurement results associated with the first cell cluster and second measurement results associated with the second cell cluster. Process 1000 may further involve processor 912 training the first AI/ML based model by using the first measurement results as model input and the second measurement results as label.

In some implementations, the first AI/ML based model is trained with or without assistance information associated with communication apparatus 910.

In some implementations, the first measurement results associated with the first cell cluster and the second measurement results associated with the second cell cluster correspond to beam level results or cell level results.

In some implementations, the first measurement results associated with the first cell cluster correspond to L1 beam level measurement results without or after L1 filtering. The first predicted results or the second measurement results associated with the second cell cluster correspond to L1 beam level measurement results, L1 cell level results, L3 beam level results, or L3 cell level results.

In some implementations, the first measurement results associated with the first cell cluster correspond to L3 beam level measurement results. The first predicted results or the second measurement results associated with the second cell cluster correspond to L3 beam level results or L3 cell level results.

In some implementations, the first measurement results associated with the first cell cluster correspond to L1 cell level measurement results. The first predicted results or the second measurement results associated with the second cell cluster correspond to L1 cell level results or L3 cell level results.

In some implementations, the first measurement results associated with the first cell cluster correspond to L3 cell level measurement results. The first predicted results or the second measurement results associated with the second cell cluster correspond to L3 cell level results.

In some implementations, data format of a measurement may include one or a combination of a cell ID, a beam ID, a beam quantity and a cell quantity.

In some implementations, a reference signal quality associated with measurement results may include SINR, RSRP, or RSRQ.

In some implementations, radio resources of the first cell cluster and/or the second cell cluster are defined by one or a combination of a temporal domain, a spatial domain, and a frequency domain.

In some implementations, the first cell cluster and/or the second cell cluster may include serving cells and neighboring cells of intra-frequency or inter-frequency.

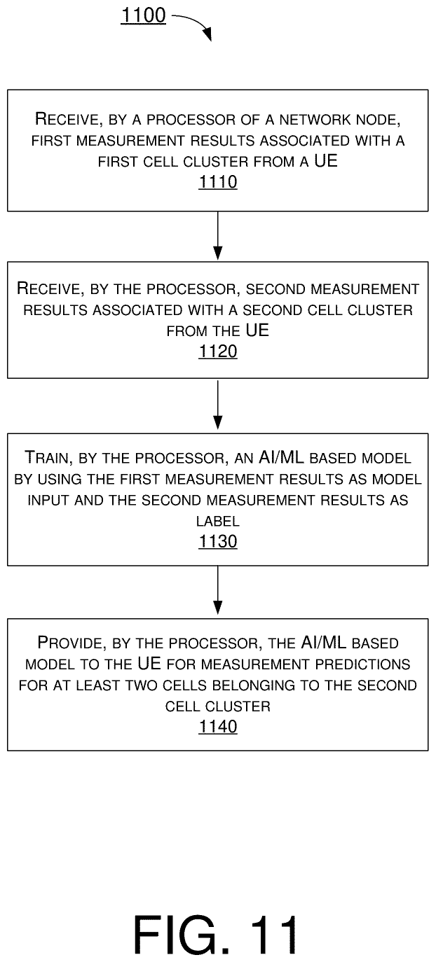

FIG. 11 illustrates an example process 1100 in accordance with an implementation of the present disclosure. Process 1100 may be an example implementation of above scenarios/schemes, whether partially or completely, with respect to cluster-based measurement prediction in mobile communications. Process 1100 may represent an aspect of implementation of features of network apparatus 920. Process 1100 may include one or more operations, actions, or functions as illustrated by one or more of blocks 1110 to 1140. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order.

Process 1100 may be implemented by network apparatus 920 or any base stations (e.g., BS 120) or network nodes (e.g., UE server). Solely for illustrative purposes and without limitation, process 1100 is described below in the context of network apparatus 920. Process 1100 may begin at block 1110.

At block 1110, process 1100 may involve processor 922 of network apparatus 920 receiving, via transceiver 926, first measurement results associated with a first cell cluster from a UE (e.g., communication apparatus 910). Process 1100 may proceed from block 1110 to block 1120.

At block 1120, process 1100 may involve processor 922 of network apparatus 920 receiving, via transceiver 926, second measurement results associated with a second cell cluster from the UE. Process 1100 may proceed from block 1120 to block 1130.

At block 1130, process 1100 may involve processor 922 training an AI/ML based model by using the first measurement results as model input and the second measurement results as label. Process 1100 may proceed from block 1130 to block 1140.

At block 1140, process 1100 may involve processor 912 providing the AI/ML based model to the UE for measurement predictions for at least two cells belonging to the second cell cluster.

In some implementations, the first cell cluster and/or the second cell cluster is determined based on one or a combination of signal measurements, geographical information, and RAN configuration.

In some implementations, the first cell cluster is identical to the second cell cluster.

In some implementations, the first cell cluster is a subset of the second cell cluster.

In some implementations, the first cell cluster is overlapping with the second cell cluster.

In some implementations, the first cell cluster and the second cell cluster may include one or more cells.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a first measurement on a first cell cluster;
obtaining, by the processor, first predicted results associated with a second cell cluster based on a first artificial intelligence (AI) or machine learning (ML) based model and first measurement results of the first measurement; and
determining, by the processor, that the apparatus moves from a first cell to a second cell,
wherein the first predicted results are associated with the first cell and the second cell in an event that the first cell and the second cell belong to the second cell cluster.

2. The method of claim 1, further comprising:
performing, by the processor, a model update to obtain a second AI or ML based model in an event that the first cell belongs to the second cell cluster and the second cell belongs to a third cell cluster different from the second cell cluster; and
obtaining, by the processor, second predicted results associated with the third cell cluster based on the second AI or ML based model.

3. The method of claim 1, wherein the first cell cluster and/or the second cell cluster is determined based on one or a combination of signal measurements, geographical information, and radio access network (RAN) configuration.

4. The method of claim 1, wherein:
the first cell cluster is identical to the second cell cluster;
the first cell cluster is a subset of the second cell cluster;
the first cell cluster is overlapping with the second cell cluster; or
the first cell cluster and the second cell cluster comprise one or more cells.

5. The method of claim 1, further comprising:
transmitting, by the processor, a measurement report to a network node according to the first measurement results associated with the first cell cluster, the first predicted results associated with the second cell cluster, or both.

6. The method of claim 5, wherein the first measurement results associated with the first cell cluster correspond to layer 1 (L1) beam level measurement results without or after L1 filtering, and the first predicted results associated with the second cell cluster correspond to L1 beam level measurement results, L1 cell level results, layer 3 (L3) beam level results, or L3 cell level results.

7. The method of claim 5, wherein the first measurement results associated with the first cell cluster correspond to layer 3 (L3) beam level measurement results, and the first predicted results associated with the second cell cluster correspond to L3 beam level results or L3 cell level results.

8. The method of claim 5, wherein the first measurement results associated with the first cell cluster correspond to layer 1 (L1) cell level measurement results, and the first predicted results associated with the second cell cluster correspond to L1 cell level results or layer 3 (L3) cell level results.

9. The method of claim 5, wherein the first measurement results associated with the first cell cluster correspond to layer 3 (L3) cell level measurement results, and the first predicted results associated with the second cell cluster correspond to L3 cell level result.

10. The method of claim 1, wherein the first predicted results associated with the second cell cluster are obtained by performing a measurement prediction at one or a combination of a temporal domain, a spatial domain, and a frequency domain with the first AI or ML based model.

11. The method of claim 1, further comprising:
collecting, by the processor, the first measurement results associated with the first cell cluster and second measurement results associated with the second cell cluster; and
training, by the processor, the first AI or ML based model by using the first measurement results as model input and the second measurement results as label.

12. The method of claim 11, wherein the first AI or ML based model is trained with or without assistance information associated with the apparatus.

13. The method of claim 11, wherein:
the first measurement results associated with the first cell cluster and the second measurement results associated with the second cell cluster correspond to beam level results or cell level results;
the first measurement results associated with the first cell cluster correspond to layer 1 (L1) beam level measurement results without or after L1 filtering, and the second measurement results associated with the second cell cluster correspond to L1 beam level measurement, L1 cell level results, layer 3 (L3) beam level results, or L3 cell level results;
the first measurement results associated with the first cell cluster correspond to L3 beam level measurement results, and the second measurement results associated with the second cell cluster correspond to L3 beam level results or L3 cell level results;
the first measurement results associated with the first cell cluster correspond to L1 cell level measurement results, and the second measurement results associated with the second cell cluster correspond to L1 cell level results or L3 cell level results; or
the first measurement results associated with the first cell cluster correspond to L3 cell level measurement results, and the second measurement results associated with the second cell cluster correspond to L3 cell level result.

14. The method of claim 1, wherein data format of measurement comprises one or a combination of a cell identifier (ID), a beam ID, a beam quantity and a cell quantity.

15. The method of claim 1, where a reference signal quality associated with measurement results comprises a signal to interference noise ratio (SINR), a reference signal received power (RSRP), or a reference signal received quality (RSRQ).

16. The method of claim 1, wherein radio resources of the first cell cluster and/or the second cell cluster are defined by one or a combination of a temporal domain, a spatial domain, and a frequency domain.

17. The method of claim 1, wherein the first cell cluster and/or the second cell cluster comprises serving cells and neighboring cells of intra-frequency or inter-frequency.

18. An apparatus, comprising:
a transceiver which, during operation, communicates wirelessly; and
a processor communicatively coupled to the transceiver such that, during operation, the processor performs operations comprising:
performing a first measurement on a first cell cluster;
obtaining first predicted results associated with a second cell cluster based on a first artificial intelligence (AI) or machine learning (ML) based model and first measurement results of the first measurement; and
determining that the apparatus moves from a first cell to a second cell,
wherein the first predicted results are associated with the first cell and the second cell in an event that the first cell and the second cell belong to the second cell cluster.

19. A method, comprising:
receiving, by a processor of a network node, first measurement results associated with a first cell cluster from a user equipment (UE);
receiving, by the processor, second measurement results associated with a second cell cluster from the UE;
training, by the processor, an artificial intelligence (AI) or machine learning (ML) based model by using the first measurement results as model input and the second measurement results as label; and
providing, by the processor, the AI or ML based model to the UE for measurement predictions for at least two cells belonging to the second cell cluster.

20. The method of claim 19, wherein:
the first cell cluster and/or the second cell cluster is determined based on one or a combination of signal measurements, geographical information, and radio access network (RAN) configuration;
the first cell cluster is identical to the second cell cluster;
the first cell cluster is a subset of the second cell cluster;
the first cell cluster is overlapping with the second cell cluster; or
the first cell cluster and the second cell cluster comprise one or more cells.
